(19) United States
(12) Patent Application Publication
(10) Pub. No.: US 2024/0253315 A1
(43) Pub. Date: Aug. 1, 2024

(54) Method for Producing a Conditioning Element, Conditioning Element and Electrical Energy Storage Device

(71) Applicant: Bayerische Motoren Werke Aktiengesellschaft, Muenchen (DE)

(72) Inventors: Dave ANDRE, Moosburg (DE); Arne MENCK, Muenchen (DE)

(21) Appl. No.: 18/562,944

(22) PCT Filed: Jun. 13, 2022
(86) PCT No.: PCT/EP2022/065982

§ 371 Date: Nov. 21, 2023

(30) Foreign Application Priority Data
Jul. 6, 2021 (DE) 10 2021 117 432.5

(51) Int. Cl. B29C 70/68; B29C 70/88; B29K 27/06; B29K 77/00; B29K 83/00; B29L 31/34; H01M 10/6556

(52) U.S. Cl. CPC B29C 70/682; B29C 70/88; H01M 10/6556; B29C 2793/0018; B29K 2027/06; B29K 2077/00; B29K 2083/00; B29L 2031/3468

(57) ABSTRACT

A method for producing a conditioning element, in particular for electrical energy storage devices, includes providing at least one channel element; and molding a structure onto the at least one channel element, at least in areas or sections.

### BACKGROUND AND SUMMARY

The present invention relates to a method for producing a conditioning element, to a conditioning element and to an electrical energy store, such as a high-voltage battery for a motor vehicle.

Electrical energy stores of the type in question are used, for example, as traction batteries in motor vehicles that are powered partially electrically or fully electrically. In order to cool, or generally condition, the plurality of energy storage cells installed in these stores, use is made of cooling plates, cooling tubes or cooling channels, such as are disclosed, for example, in US 2011/0212356 A1. The production of such elements is quite complex in practice, since the cooling elements, inter alia, have to be electrically insulated. It is also not unproblematic that connections, connecting points and/or branching points, etc. have to be provided, which are not readily producible. Cooling elements often consist of metal tubes, in particular aluminum tubes, which are not optimally suited to some joining methods, such as welding.

It is therefore an object of the present invention to provide a method for producing a conditioning element, a conditioning element and an electrical energy store, the method being distinguished in particular by its flexibility and robustness, as a result of which it is possible to generate conditioning elements which can meet the highest quality and performance requirements while simultaneously involving low costs.

This object is achieved by a method, a conditioning element, and an electrical energy store according to the claimed invention.

According to embodiments of the invention, a method for producing a conditioning element, in particular for electrical energy stores, comprises the steps of providing at least one channel element; and integrally forming a structure at least in certain regions or portions, in particular by way of primary forming.

The aforementioned conditioning element is, in particular, a cooling element, wherein the expression “cooling element” must not be understood as meaning that only cooling is possible therewith. Instead, the cooling element also enables heating, if necessary, thus in particular temperature control or conditioning. In the installed state, the conditioning element bears indirectly and/or directly against one or more energy storage cells and is designed to in particular dissipate heat from said cells or, conversely, to heat or warm up the energy storage cells. To this end, the conditioning element comprises the at least one channel element, the at least one channel element forming a cooling channel which is designed to transport a fluid, for example a gaseous medium, but in particular a liquid medium. The major advantage then is that the structure is integrally formed directly onto the channel element. Advantageously, no subsequent mounting or arranging of a structure by way of form-fitting and/or force-fitting and/or materially bonded connecting techniques is required, rather the structure is integrally formed directly and immediately onto the channel element, with primary forming methods preferably being used for this.

The aforementioned integral forming offers, inter alia, the advantage that it is considerably more robust than for example powder or wet coating methods. Complex masking is also not necessary, since it is possible for the structure to be applied only exactly where it is needed.

The direct integral forming of the structure also offers the advantage that the channel element as such can be held in simple manner. More complex geometries, where necessary, can be formed over the structure. This allows, inter alia, work to be performed with commonly used or identical parts within the manufacture of the conditioning elements for different power outputs of energy stores.

According to a preferred embodiment, the integral forming is effected by way of primary forming, in particular injection molding, transfer molding or extrusion, where this enumeration should not be understood as being conclusive.

According to one embodiment, the method comprises the step of arranging the at least one channel element in or on a tool for the integral forming of the structure, in particular by way of primary forming.

According to one embodiment, the aforementioned tool is an injection-molding tool, comprising for example two tool halves which in a closed state form a cavity in which the channel element is partially or completely arranged. In this configuration, according to one embodiment, the channel element may be overmolded or encapsulated completely or at least in certain parts or regions, in order to generate an insulation layer of a desired thickness. This is a discontinuous process. According to one embodiment, in such a configuration, an additional, in particular functional component, such as a contact element or connecting element, a cooling channel portion, a holder or the like is integrally formed in the injection mold. In other words, it is possible for a component or a structural part which can perform further functions, such as the connection to another cooling element or channel element, etc., to be integrally formed onto the channel element.

According to one embodiment, the structure is subsequently machined, in particular mechanically. It is thus for example possible for holes, bores, threads and the like to be introduced into the structure.

According to one embodiment, the structure is provided and/or designed for connection to further components, a large number of joining methods, such as adhesive bonding, laser welding, hot caulking, etc., being possible for this. Equally, a further integral forming operation, in particular by way of primary forming, is possible.

According to one embodiment, the method comprises the step of arranging the at least one channel element in or on a tool for the integral forming operation, in particular by way of primary forming, and displacing the channel element during the integral forming of the structure.

Here, the structure is applied to the channel element, similarly to an extrusion process. To this end, the corresponding tool for example comprises a die through which the channel element is guided. Depending on the configuration of the die, it is possible here to generate particularly good insulation layers. Depending on the configuration of the dies, it is also possible here to generate outer contours which serve, for example, as holders or tabs. According to one embodiment, the insulation layer has a surface structure, comprising one or more extensions, projections and/or recesses, etc., in order to optimize a heat transfer and/or an arrangement of the energy storage cells.

According to one embodiment, the at least one channel element is an extruded profile, preferably a metallic extruded profile, in particular an aluminum extruded profile. As an alternative, the channel element may also be formed from a non-metallic material, such as a plastic or a composite material, or from a material combination of metallic and non-metallic materials.

The material used for the structure is preferably a non-metallic material, such as a plastic, for example polyvinyl chloride (PVC), polyamide (PA), silicone, etc.

According to one embodiment, the structure is solid or hard in the end state. As an alternative, the structure is flexible, in particular elastically deformable, in the end state. In addition to a high degree of geometrical freedom, the integral forming, and in particular the use of primary forming methods, in particular also enables a very great degree of freedom with regard to the materials used for the structure. It should be mentioned at this point that the structure as such may also comprise a plurality of materials and in particular as such also a plurality of layers. The use of composite materials is also possible and expedient, particularly if the structure is at least partially intended to perform a load-bearing function or as such itself forms one or more (cooling) channels.

According to one embodiment, the method comprises the step of integrally forming the structure onto a plurality of channel elements.

Expediently, a structure, or a plurality of structures, is integrally formed in particular simultaneously onto a plurality of channel elements. With a conditioning element configured in this way, it is possible for not only the cooling performance to be increased. In particular, it is thus possible to influence a shape of the conditioning element. According to a preferred embodiment, a plurality of round or circular channel elements are arranged one above the other and form a conditioning element or cooling element having a flat, approximately rectangular cross section. Such a cooling element is suitable, for example, for arrangement between and/or on round cells or prismatic cells.

According to one embodiment, the at least one channel element has a round, in particular a circular, cross section, however angular cross-sectional shapes, such as quadrangular, in particular square or rectangular shapes, are additionally also expedient, depending on the application. Particularly if the channel element is produced by way of extrusion, there are high degrees of freedom with regard to the shaping.

According to one embodiment, the at least one channel element as such is rectilinear or has a rectilinear profile. According to one embodiment, a plurality of rectilinear channel elements are used which are built up by way of one or more structures to form a conditioning element which comprises a complex channel profile, such as a meandering profile of the cooling channels.

According to one embodiment, the method comprises the step of forming or deforming the channel element in certain regions or portions after the structure has been integrally formed.

The integral forming and/or deforming can be carried out when the structure itself is still flexible. The integral forming or deforming should for example be understood as meaning that radii, curves and/or the like are introduced into the channel element. As an alternative, the channel element already has a non-rectilinear shape prior to the integral forming operation or the channel element is deformed in certain regions or portions prior to the integral forming of the structure.

According to one embodiment, a corrugated profile is generated during the deforming of the channel element. This is particularly advantageous if the channel element or the conditioning element is provided for arrangement on round cells, since this makes it possible to increase the heat-transferring area in relation thereto.

The invention is also directed to a conditioning element, in particular a cooling element, comprising at least one channel element, in particular composed of a first material, on which a structure, in particular composed of a second material, is integrally formed. Here, the second material is a material which differs from the first material.

According to a preferred embodiment, the conditioning element is produced by the method described herein. Irrespective thereof, the advantages and features mentioned in conjunction with the method apply in an analogous and corresponding manner to the conditioning element, and vice versa.

According to one embodiment, the structure is an insulation layer. The insulation layer may be applied to or arranged on the channel element completely or intermittently. Intermittently should be understood as meaning that for example only the end portions of the channel element comprise an insulation layer. As an alternative, only the middle region or the middle portion of the channel element is coated, while the start and end regions are uncoated. In a peripheral direction of the channel element, the layer may be applied completely or only in certain portions. According to one embodiment, the structure is a contact element or connecting element. A contact element or connecting element should for example be understood to mean a connection which serves for the arrangement of another component or another channel element or conditioning element. The arrangement may be effected in a form-fitting and/or force-fitting and/or materially bonded manner. According to one embodiment, to this end, the structure comprises corresponding fasteners, such as threads, holes, bores or the like. These may be introduced for example mechanically after the structure has been integrally formed.

According to one embodiment, the structure forms a cooling channel portion (more generally: channel portion) or comprises such a portion. According to one embodiment, the cooling channel portion also forms the cooling channel portion of the channel element. The cooling channel portion formed by the structure has, for example, a non-rectilinear shape, for example a curved shape, while the channel element itself is rectilinear. It is thus possible to generate conditioning elements of any desired geometry by way of a corresponding number of channel elements and correspondingly shaped structures.

According to one embodiment, at least one structure is integrally formed onto the at least one channel element. Here, the different structures may each be generated differently, for example an insulation layer by way of extrusion and a connection by way of injection molding.

According to one embodiment, the method comprises the steps of unwinding a strip-like channel element, provided in particular in a wound-up form, and integrally forming a structure, in particular an insulation layer, by way of primary forming, preferably by way of extrusion; and winding up the channel element after the structure has been integrally formed.

In the present case, a continuous process is expediently concerned. Advantageously, a roll-to-roll process is made possible. A basic material, for example an aluminum extruded roll, is unrolled, provided with one or more structures and subsequently either rolled up again for later use or immediately cut to the desired length and further processed. Here, a material which provides appropriate flexibility should be selected for the structure.

According to one embodiment, in a continuous process, such as just explained, a test, for example a test of the properties and/or the quality of the structure, such as the insulation layer, is integrated, preferably in-line. The test is preferably embodied as an insulation test if the structure is an insulation layer. As an alternative to the voltage test, optical methods and determinations of the thickness of the insulation layer are also possible. In this way, the production can advantageously be monitored in a continuous and rapid manner.

The invention also relates to an electrical energy store, comprising at least one conditioning element according to embodiments of the invention. According to a preferred embodiment, the electrical energy store is a traction battery which is designed for use in a motor vehicle that is powered partially electrically or fully electrically, such as a motorcycle or in particular a passenger car, or generally for use in land vehicles.

The energy store preferably comprises a plurality of energy storage cells, wherein in particular prismatic cells or preferably round cells are used. According to one embodiment, the conditioning element comprises a channel element which is formed to form a conditioning element running in a meandering manner, wherein in each case a plurality of energy storage cells, in particular round cells, are arranged between the strands formed here. As an alternative, use is made of a plurality of channel elements which are connected by way of one or more structures in such a way that a meandering conditioning element is formed.

Here, the configuration as a meandering conditioning element should be understood as being only exemplary, since the method in particular entails the advantage that the geometry of the conditioning element can be designed very flexibly, whether it be through the use of channel elements of different shape and/or length or through the possibility of subsequent deformation or shaping of same.

According to one embodiment, the conditioning element forms a cooling plate, on which a plurality of energy storage cells are arranged. Here, too, the possibilities are extremely varied due to the flexible production method.

Further advantages and features will emerge from the following description of embodiments of the method or of conditioning elements with reference to the attached figures.

### BRIEF DESCRIPTION OF THE DRAWINGS

FIG. 1 shows a plurality of schematic sectional views of embodiments of conditioning element.

FIG. 2 shows a further embodiment of a conditioning element with an intermittently applied structure.

FIG. 3 shows a further embodiment of a conditioning element.

FIG. 4 shows a schematic view which illustrates one embodiment of the production method.

FIG. 5 shows a further schematic view which illustrates one embodiment of the production method.

FIG. 6 shows a schematic depiction of one embodiment of a conditioning element.

### DETAILED DESCRIPTION OF THE DRAWINGS

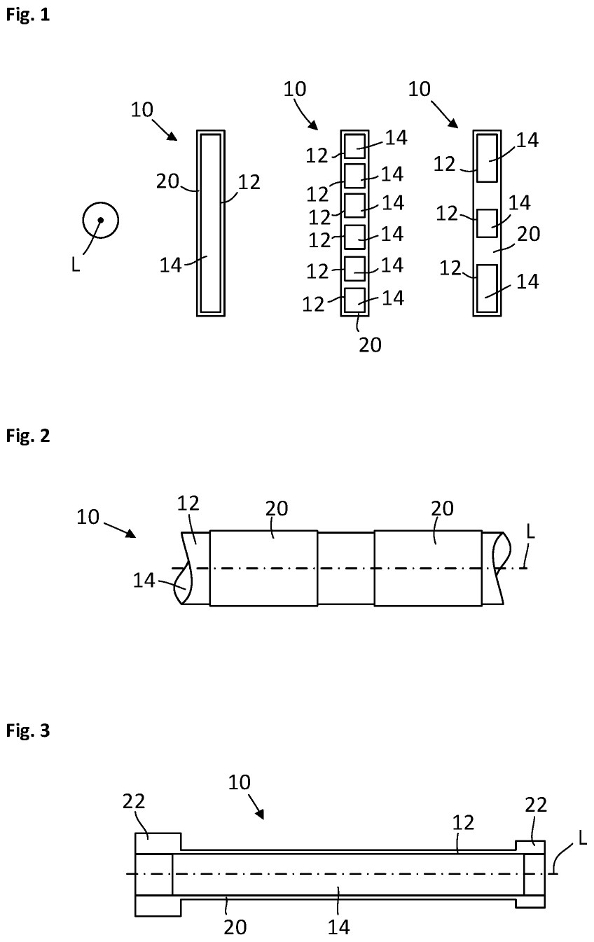

FIG. 1 shows three depictions of conditioning elements, in particular cooling elements 10, which extend along a longitudinal axis L, in section. On the left it is possible to see a channel element 12 having a substantially rectangular cross section. This forms a cooling channel 14. A structure is integrally formed onto the channel element 12 peripherally, in the present case fully peripherally. In the present case, the structure is in the form of an, in particular electrical, insulation layer 20. In the middle illustration, a conditioning element 10 comprises a plurality, in the present case in particular five, channel elements 12 which are arranged one above the other and which each form a cooling channel 14. In the right-hand half of the image, the conditioning element comprises three channel elements 12 of different shape which each form a cooling channel 14. In all cases, a or the structure is integrally formed directly onto the channel elements 12, wherein here in particular primary forming methods, such as injection molding, transfer molding or extrusion, should be mentioned as preferred.

FIG. 2 shows a further embodiment of a conditioning element 10, comprising a channel element 12 which comprises a cooling channel 14. The channel element 12, which for example has an oval or round shape, is peripherally provided intermittently along a longitudinal axis L with a structure, in the present case also in the form of an insulation layer 20. A structure configured in this way may be generated, for example, by way of encapsulation in the context of an extrusion method.

FIG. 3 shows a further schematic depiction of a conditioning element 10, comprising a channel element 12 together with a cooling channel 14. Structures are arranged or integrally formed in each case at the end of the channel element 12 and form contact elements or connecting elements 22. It can also be seen that the components 22 continue the cooling channel 14, which is formed substantially by the channel element 12, at the end. Moreover, the structure forms an insulation layer 20 around the channel element 12. The end-side components 22 are illustrated merely schematically in the present case. According to one embodiment, said components may, for example, be in the form of connections, which may be used as plug-in connections. In addition or as an alternative, a fastener, such as a thread or the like, may be provided on at least one of the components, etc.

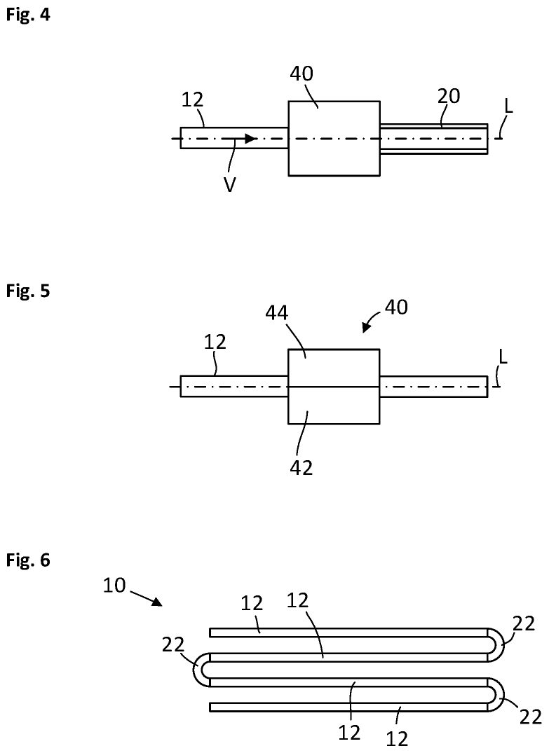

FIG. 4 shows a schematic view of a tool 40, in which a channel element 12 is arranged. In the present case, a continuous process is depicted, in which the channel element 12 is displaced along a feed direction V in order for an insulation layer 20 to be integrally formed thereon, for example by way of extrusion.

FIG. 5 shows, as an alternative to the embodiment in FIG. 4, a tool comprising a lower tool half 42 and an upper tool half 44, which form a cavity (not shown here) by way of which a structure can be integrally formed onto a channel element 12, for example by way of injection molding or transfer molding.

FIG. 6 shows a further schematic view of a conditioning element 10, the latter comprising a plurality of channel elements 12 which as such have an identical length and are each of rectilinear form. Components 22 which are integrally formed in an appropriate manner make it possible to generate a conditioning element 10 having a meandering profile. For the purpose of electrical insulation, an insulation layer can be integrally formed onto the channel elements 12 (this is not illustrated in the present case).

### LIST OF REFERENCE DESIGNATIONS

10 Conditioning element, cooling element
12 Channel element
14 Cooling channel
20 (Insulation) layer
22 Component, contact element/connecting element, (cooling) channel portion
40 Tool
42 Lower tool half
44 Upper tool half
V Feed direction
L Longitudinal axis.

1.-13. (canceled)

14. A method for producing a conditioning element for electrical energy stores, the method comprising:
providing at least one channel element; and
integrally forming a structure onto the at least one channel element at least in certain regions or portions.

15. The method according to claim 14, further comprising:
performing the integrally forming by primary forming, transfer molding or extrusion.

16. The method according to claim 14, further comprising:
performing the integrally forming by injection molding, transfer molding or extrusion.

17. The method according to claim 14, further comprising:
arranging the at least one channel element in or on a tool for the integral forming of the structure.

18. The method according to claim 14, further comprising:
arranging the at least one channel element in or on a tool and displacing the channel element during the integrally forming of the structure.

19. The method according to claim 14, wherein the structure is at least one of a layer or an additional component.

20. The method according to claim 14, wherein the at least one channel element is an extruded profile.

21. The method according to claim 14, further comprising:
integrally forming the structure onto a plurality of channel elements.

22. The method according to claim 14, further comprising:
forming or primary forming of the channel element in certain regions or portions after the structure has been integrally formed.

23. A conditioning element comprising:
at least one channel element on which a structure is integrally formed.

24. The conditioning element according to claim 23, wherein the at least one channel element is composed of a first material.

25. The conditioning element according to claim 24, wherein the structure is composed of a second material.

26. The conditioning element according to claim 23, wherein the structure is an insulation layer.

27. The conditioning element according to claim 23, wherein the structure is a contact element.

28. The conditioning element according to claim 23, wherein the structure is a cooling channel portion.

29. An electrical energy store comprising the conditioning element according to claim 23.
